(19) United States
(12) Patent Application Publication
(10) Pub. No.: US 2021/0051287 A1
(43) Pub. Date: Feb. 18, 2021

(54) IMAGING SYSTEMS AND METHODS FOR OPERATING A VARIABLE CONVERSION GAIN PIXEL FOR ANALOG DOMAIN REGIONAL FEATURE EXTRACTION

(71) Applicant: SEMICONDUCTOR COMPONENTS INDUSTRIES, LLC, Phoenix, AZ (US)

(72) Inventors: Roger PANICACCI, Los Gatos, CA (US); Tim CHAN, Los Gatos, CA (US)

(73) Assignee: SEMICONDUCTOR COMPONENTS INDUSTRIES, LLC, Phoenix, AZ (US)

(21) Appl. No.: 16/827,960

(22) Filed: Mar. 24, 2020

Related U.S. Application Data
(60) Provisional application No. 62/886,613, filed on Aug. 14, 2019.

(51) Int. Cl. H04N 5/369; H04N 5/378; H04N 5/3745

(52) U.S. Cl. CPC H04N 5/379; H04N 5/3745; H04N 5/378

(57) ABSTRACT

Imaging circuitry may include circuits for implementing current or voltage mode feature extraction in the analog domain. The imaging circuitry may include pixels configured to generate pixel values. The pixel values may then be weighted using adjustable weighting circuits to generate corresponding weighted pixel values. The adjustable weighting circuits may be selectively coupled to the floating diffusion node in each pixel. The weighted pixels values may then be combined to obtain an output neuron voltage for at least one layer in a neural network. Performing feature extraction in the analog domain for each layer of results in the neural network saves power and area by avoiding the need to move data around to conventional digital memories.

This application claims the benefit of provisional patent application No. 62/886,613, filed Aug. 14, 2019, which is hereby incorporated by reference herein in its entirety.

### BACKGROUND

This relates generally to imaging devices, and more particularly, to imaging devices having image sensor pixels on wafers that are stacked on other image readout/signal processing wafers.

Image sensors are commonly used in electronic devices such as cellular telephones, cameras, and computers to capture images. In a typical arrangement, an image sensor includes an array of image pixels arranged in pixel rows and pixel columns. Circuitry may be coupled to each pixel column for reading out image signals from the image pixels.

Imaging systems may implement convolutional neural networks (CNN) to perform feature extraction (i.e., to detect one or more objects, shapes, edges, or other scene information in an image). Feature extraction can be performed in a smaller region of interest (ROI) having a lower resolution than the entire pixel array. Typically, the analog pixel values in the lower resolution ROI are read out, digitized, and stored for subsequent processing for feature extraction and convolution steps.

### BRIEF DESCRIPTION OF THE DRAWINGS

FIG. 1 is a diagram of an illustrative electronic device having an image sensor and processing circuitry for capturing images using an array of image pixels in accordance with some embodiments.

FIG. 2 is a diagram of an illustrated stacked imaging system in accordance with an embodiment.

FIG. 3 is a diagram of an illustrative image sensor array coupled to digital processing circuits and analog processing circuits in accordance with an embodiment.

FIG. 4A is a diagram showing how an image pixel may be connected to a particular region of interest (ROI) via various switch networks in accordance with an embodiment.

FIG. 4B is a diagram of an illustrative ROI unit cell in accordance with an embodiment.

FIG. 5 is a diagram showing how a convolution kernel may be applied to an ROI to extract features in accordance with an embodiment.

FIG. 6A is a diagram showing how variable weights can be implemented using input current mode multiplier accumulator circuitry in accordance with an embodiment.

FIG. 6B is a diagram of a variable capacitor array that can be shared among multiple pixels in accordance with an embodiment.

FIG. 6C is a flow chart of illustrative steps for operating the circuitry shown in FIG. 6A in accordance with an embodiment.

FIG. 6D is a timing diagram showing relevant signals for operating the circuitry shown in FIG. 6A in accordance with an embodiment.

FIG. 7A is a diagram showing how variable weights can be implemented using switched capacitor voltage mode analog multiplier accumulator circuitry in accordance with an embodiment.

FIG. 7B is a flow chart of illustrative steps for operating the circuitry shown in FIG. 7A in accordance with an embodiment.

FIG. 7C is a timing diagram showing relevant signals for operating the circuitry shown in FIG. 7A in accordance with an embodiment.

FIG. 7D is a timing diagram showing relevant signals for operating the circuitry shown in FIG. 7A when the variable weighting capacitors are shared among multiple rows in accordance with an embodiment.

### DETAILED DESCRIPTION

Electronic devices such as digital cameras, computers, cellular telephones, and other electronic devices may include image sensors that gather incoming light to capture an image. The image sensors may include arrays of image pixels. The pixels in the image sensors may include photosensitive elements such as photodiodes that convert the incoming light into image signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the image pixels and readout circuitry for reading out image signals corresponding to the electric charge generated by the photosensitive elements.

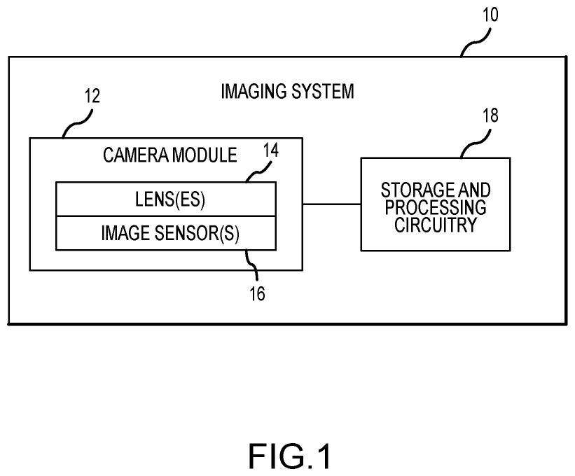

FIG. 1 is a diagram of an illustrative imaging system such as an electronic device that uses an image sensor to capture images. Electronic device 10 of FIG. 1 may be a portable electronic device such as a camera, a cellular telephone, a tablet computer, a webcam, a video camera, a video surveillance system, an automotive imaging system, a video gaming system with imaging capabilities, or any other desired imaging system or device that captures digital image data. Camera module 12 may be used to convert incoming light into digital image data. Camera module 12 may include one or more lenses 14 and one or more corresponding image sensors 16. Lenses 14 may include fixed and/or adjustable lenses and may include microlenses formed on an imaging surface of image sensor 16. During image capture operations, light from a scene may be focused onto image sensor 16 by lenses 14. Image sensor 16 may include circuitry for converting analog pixel data into corresponding digital image data to be provided to storage and processing circuitry 18. If desired, camera module 12 may be provided with an array of lenses 14 and an array of corresponding image sensors 16.

Storage and processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image data that has been captured by camera module 12 may be processed and stored using processing circuitry 18 (e.g., using an image processing engine on processing circuitry 18, using an imaging mode selection engine on processing circuitry 18, etc.). Processed image data may, if desired, be provided to external equipment (e.g., a computer, external display, or other device) using wired and/or wireless communications paths coupled to processing circuitry 18.

In accordance with an embodiment, groups of pixel values in the analog domain may be processed to extract features associated with objects in a scene. The pixel information is not being digitized to a low resolution region of interest. The feature information extracted from a pixel array can be processed in multiple steps of a convolutional neural network (as an example) using this analog implementation to identify scene information for the system, which can then be used to decide whether or not to output pixel information at a higher resolution in that region of the scene.

Die stacking may be leveraged to allow the pixel array to connect to corresponding region of interest (ROI) processors to enable efficient analog domain feature extraction (e.g., to detect object features of interest and temporal changes for areas of the array that are not being read out at full resolution through the normal digital signal processing path). Extracted features may be temporarily stored in the analog domain, which can be used to check for changes in feature values over time and to detect changes in key features related to objects in the scene.

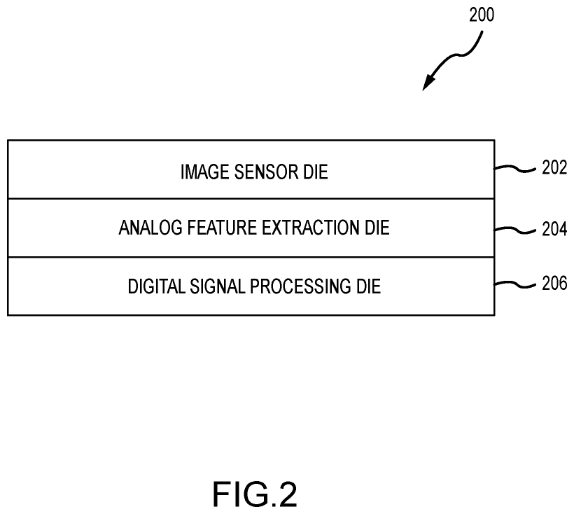

FIG. 2 is a diagram of an illustrated stacked imaging system 200. As shown in FIG. 2, system 200 may include an image sensor die 202 as the top die, a digital signal processor die 206 as the bottom die, and an analog feature extraction die 204 that is stacked vertically between top die 202 and bottom die 206. The array of image sensor pixels reside within the top image sensor die 202; the normal digital readout circuits reside within the bottom die 206; and the analog domain feature extraction circuitry are formed within the middle die 204. If desired, other ways of stacking the various imager dies may also be used.

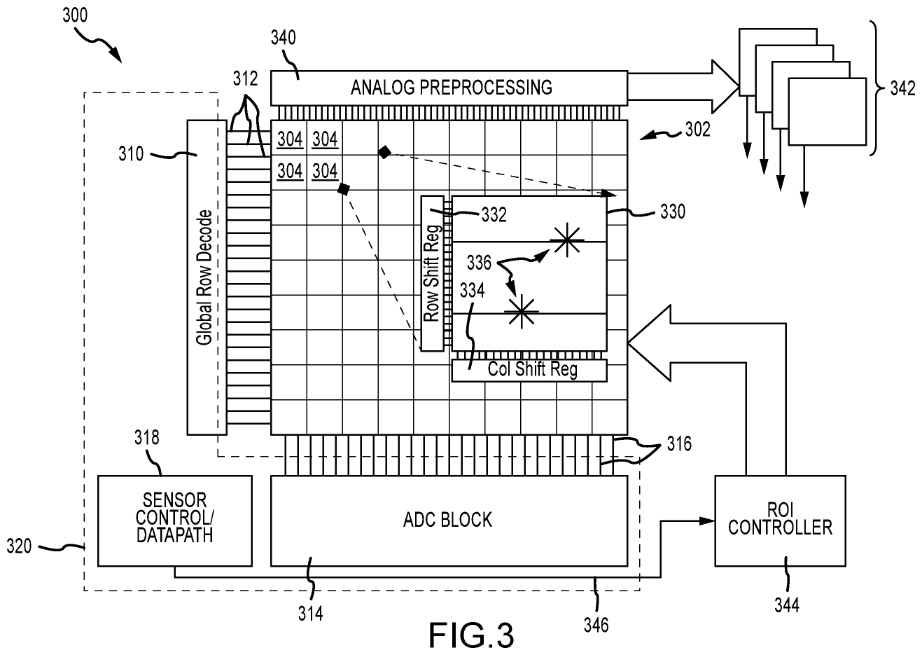

FIG. 3 is a diagram of an illustrative image sensor array 302 coupled to digital processing circuits and analog processing circuits. The digital signal processing circuits are delineated by dotted box 320, which include a global row decoder 310 configured to drive all the pixel rows within array 302 via row control lines 312, an analog-to-digital converter (ADC) block 314 configured to receive pixels values via each pixel column through the normal readout paths 316, and a sensor controller 318. These digital signal processing circuits 320 may reside within the bottom die 206 (see FIG. 2).

The image pixel array 302 may be formed on the top image sensor die 202. Pixel array 302 may be organized into groups sometimes referred to as “tiles” 304. Each tile 304 may, for example, include 256×256 image sensor pixels. This tile size is merely illustrative. In general, each tile 304 may have a square shape, a rectangular shape, or an irregular shape of any suitable dimension (i.e., tile 304 may include any suitable number of pixels).

Each tile 304 may correspond to a respective “region of interest” (ROI) for performing feature extraction. A separate ROI processor 330 may be formed in the analog die 204 below each tile 304. Each ROI processor 330 may include a row shifter register 332, a column shift register 336, and row control and switch matrix circuitry for selectively combining the values from multiple neighboring pixels, as represented by converging lines 336. Signals read out from each ROI processor 330 may be fed to analog processing and multiplexing circuit 340 and provided to circuits 342. Circuits 342 may include analog filters, comparators, high-speed ADC arrays, etc. Sensor control 318 may send signals to ROI controller 344, which controls how the pixels are read out via the ROI processors 330. For example, ROI controller 344 may optionally control pixel reset, pixel charge transfer, pixel row select, pixel dual conversion gain mode, a global readout path enable signal, a local readout path enable signal, switches for determining analog readout direction, ROI shutter control, etc. Circuits 330, 340, 342, and 344 may all be formed within the analog die 204.

An imaging system configured in this way may support content aware sensing. The analog readout path supports rapid scanning for shape/feature detection, non-destructive intensity thresholding, temporal events, and may also use on-board vision smart components to process shapes. The high-speed ROI readout path can also allow for digital accumulation and burst readout without impact to the normal frame readout. This content aware sensor architecture reads out different regions at varying resolutions (spatial, temporal, bit depth) based on the importance of that part of the scene. Smart sensors are used to monitor activity/events in regions of the image that are not read out at full resolution to determine when to wake up that region for higher resolution processing. The analog feature extraction supports monitoring of activity in those particular regions of interest without going into the digital domain. Since the analog feature extraction does not require processing through an ADC, a substantial amount of power can be saved.

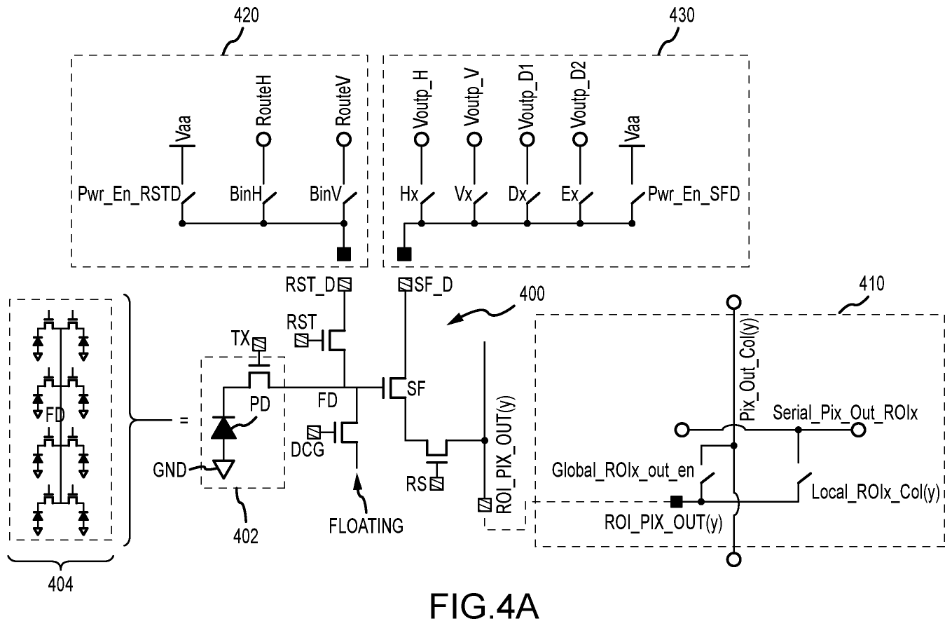

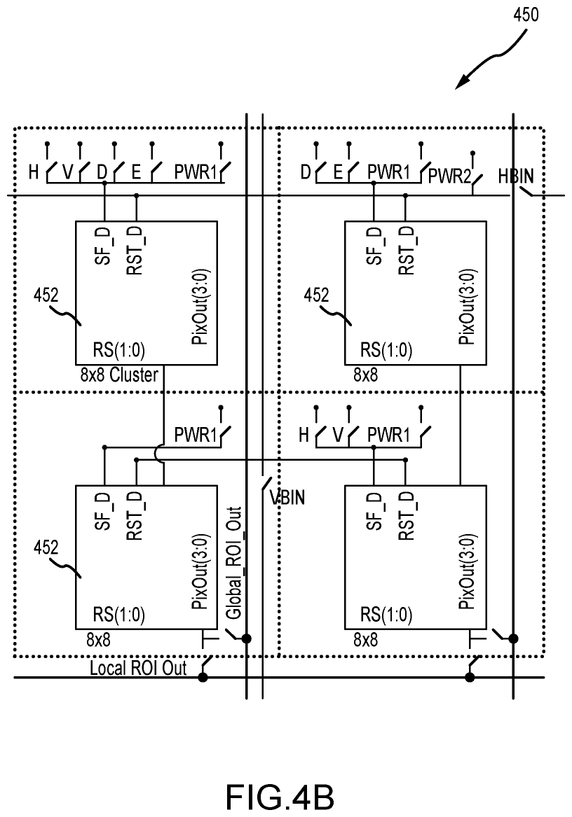

FIG. 4A is a diagram showing how an image pixel may be connected to a particular region of interest (ROI) via various switch networks. As shown in FIG. 4A, an image sensor pixel such as pixel 400 may include a photodiode PD coupled to a floating diffusion node FD via a charge transfer transistor, a reset transistor coupled between the FD node and a reset drain node RST_D, a dual conversion gain (DCG) transistor having a first terminal connected to the FD node and a second terminal, a source follower transistor with a drain node SF_D, a gate terminal connected to the FD node, and a source node coupled to the ROI pixel output line via a corresponding row select transistor. Portion 402 of pixel 404 may alternatively include multiple photodiodes that share a single floating diffusion node, as shown by configuration 404.

In the example of FIG. 4A, each reset drain node RST_D within an 8×8 pixel cluster may be coupled to a group of reset drain switches 420. This is merely illustrative. In general, a pixel cluster that share switches 420 may have any suitable size and dimension. Switches 420 may include a reset drain power enable switch that selectively connects RST_D to positive power supply voltage Vaa, a horizontal binning switch BinH that selectively connects RST_D to a corresponding horizontal routing line RouteH, a vertical binning switch BinV that selectively connects RST_D to a corresponding vertical routing line RouteV, etc. Switch network 420 configured in this way enables connection to the power supply, binning charge from other pixels, focal plane charge processing.

Each source follower drain node SF_D within the pixel cluster may also be coupled to a group of SF drain switches 430. Switch network 430 may include a SF drain power enable switch Pwr_En_SFD that selectively connects SF_D to power supply voltage Vaa, switch Hx that selectively connects SF_D to a horizontal line Voutp_H, switch Vx that selectively connects SF_D to a vertical line Voutp_V, switch Dx that selectively connects SF_D to a first diagonal line Voutp_D1, switch Ex that selectively connects SF_D to a second diagonal line Voutp_D2, etc. Switches 430 configured in this way enables the steering of current from multiple pixel source followers to allow for summing/differencing to detect shapes and edges and connection to a variable power supply.

Each pixel output line ROI_PIX_OUT(y) within the pixel cluster may also be coupled to a group of pixel output switches 410. Switch network 410 may include a first switch Global_ROIx_out_en for selectively connecting the pixel output line to a global column output bus Pix_Out_Col(y) and a second local switch Local_ROIx_Col(y) for selectively connecting the pixel output line to a local ROI serial output bus Serial_Pix_Out_ROIx that can be shared between different columns. Configured in this way, switches 410 connects each pixel output from the ROI to one of the standard global output buses for readout, to a serial readout bus to form the circuit used to detect shapes/edges, to a high speed local readout signal chain, or a variable power supply.

FIG. 4B is a diagram of an illustrative ROI unit cell 450. In the example of FIG. 4B, each ROI unit cell 450 may include four 8×8 pixel clusters 452 that share the various switch networks described in connection with FIG. 4A. In the example of FIG. 4B, each cluster 452 may have a different number of SF_D switches. For example, the top left cluster may be coupled to five SF_D switches while the top right cluster may only be coupled to three SF_D switches. This is merely illustrative. If desired, each cluster 452 may be coupled to any suitable number of SF_D switches. In the example of FIG. 4B, the various clusters 452 may be coupled to shared horizontal and vertical binning switches. Moreover, the clusters along each column may be coupled to a respective global output bus, whereas all of the clusters in unit cell 450 may be coupled to a common local ROI serial output bus.

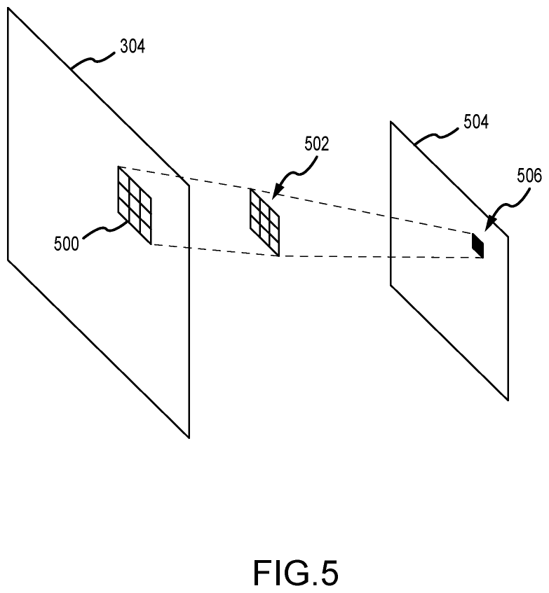

Machine vision applications use algorithms to find features and objects using fundamental operations that weight groups of pixels and sum them together. FIG. 5 is a diagram showing how a convolution kernel 502 may be applied to a tile 304 or ROI to extract features 506. Convolution kernel 502 may include a collection of weights. Convolution kernel 502 may be applied to a corresponding window 500 sliding across ROI 304. In the example of FIG. 5, kernel 502 is shown as a 3×3 matrix. This is, however, merely illustrative. Kernel 502 may be a 5×5 array of weights or a matrix of any suitable size or dimension. Each weight can either be positive or negative. Each kernel window 500 performs an analog multiply accumulate (MAC) operation (e.g., using 2 dimensional matrix multiplications) to obtain a resulting convolution feature 506. Multiple convolution features 506 may be combined into a feature map 504 that is the same size or optionally smaller than tile 304. Other ways of generating CNN layers may also be implemented.

The convolution operation illustrated in FIG. 5 is conventionally performed in the digital domain using binary values. In accordance with an embodiment, the MAC operations may be performed in the analog domain to reduce the need for excessive analog-to-digital conversion (which can save power) and to reduce the need for high bandwidth digital bus structures. For example, the MAC operation can be performed directly at a per pixel level using a variable conversion gain capacitor array to perform the multiply/weighting operation and using analog summing circuits to sum multiple pixel values simultaneously.

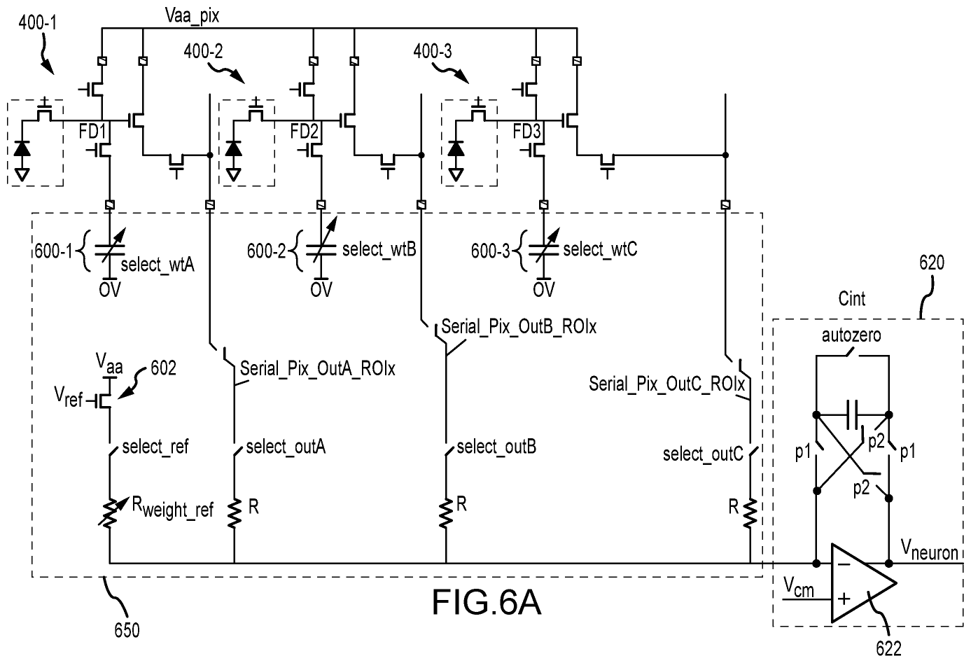

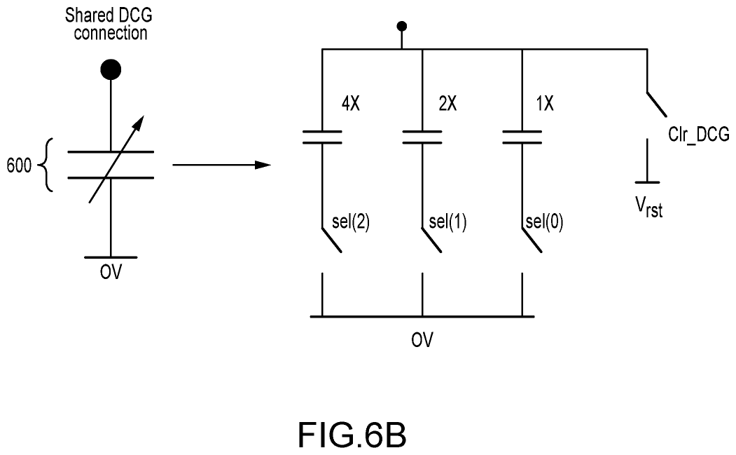

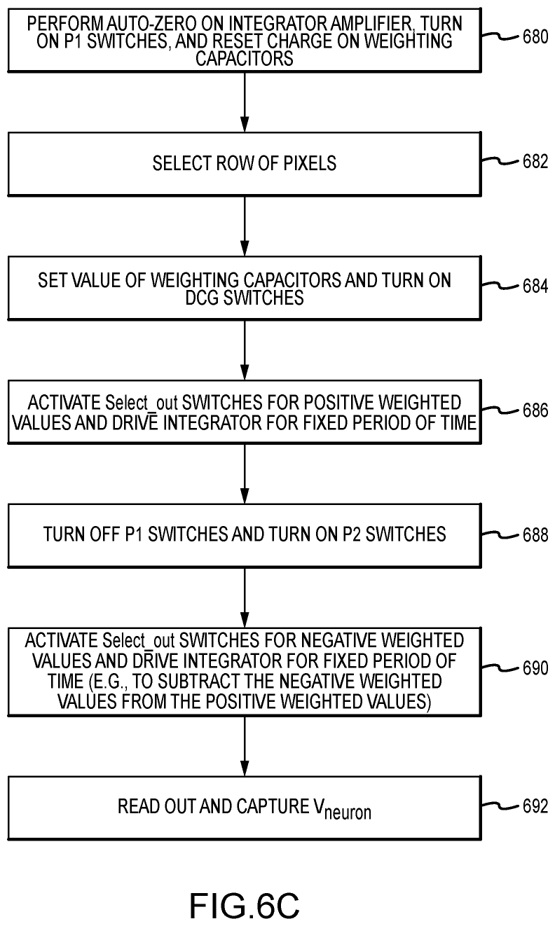

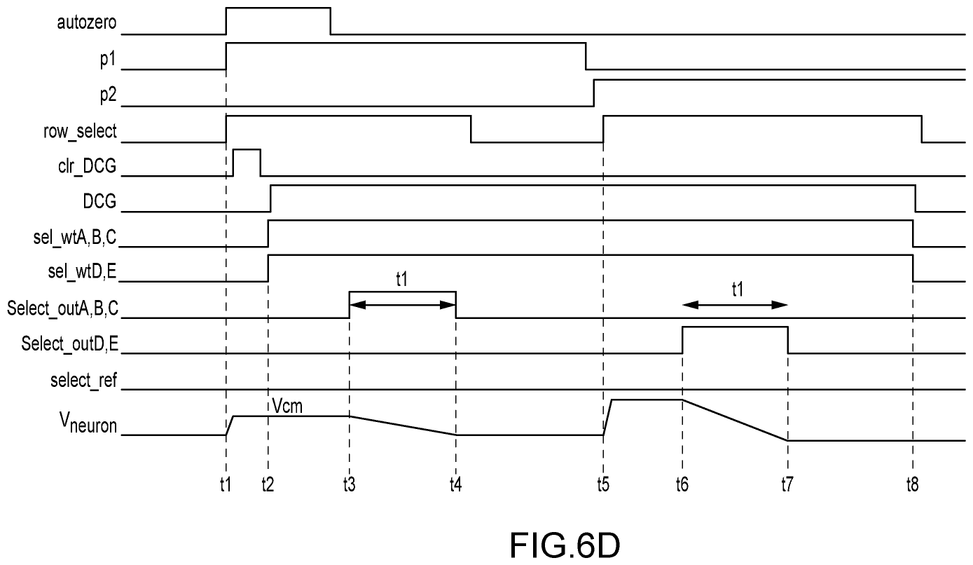

FIG. 6A is a diagram showing how variable weights can be implemented using input current mode multiplier accumulator circuitry 650. As shown in FIG. 6A, pixels 400-1, 400-2, 400-3, and other image pixel along a given row in the pixel array may have their reset drain nodes RST_D and source follower drain nodes SF_D coupled to positive power supply voltage Vaa pix. The second (bottom) terminal of the dual conversion gain (DCG) transistors may be coupled to a respective variable capacitor 600. In the example of FIG. 6A, the DCG transistor of pixel 400-1 may be connected to a first variable capacitor 600-1; the DCG transistor of pixel 400-2 may be connected to a second variable capacitor 600-2; the DCG transistor of pixel 400-3 may be connected to a third variable capacitor 600-3; and so on.

FIG. 6B is a diagram showing one suitable implementation of a variable capacitor 600. Capacitor 600 may include a bank of capacitors with different sizes, which can be selectively switches into use by asserting one or more select bits. In FIG. 6B, select bits [2:0] may be set equal to “001” to only activate the least significant bit (LSB) capacitor, may be set equal to “100” to only activate the most significant bit (MSB) capacitor that might be 4x the size of the LSB capacitor, may be set equal to “011” to activate the LSB capacitor and the intermediate capacitor that might be 2x the size of the LSB capacitor, etc. A clear signal Clr_DCG may be asserted to reset the variable capacitor bank (e.g., to apply a reset voltage Vrst to the top terminal of the variable capacitor bank to discharge all of the capacitors). The bit depth of kernel weights is determined by the number of variable sized capacitors in each bank. In general, each variable capacitor 600 may include any suitable number of capacitors in different sizes. The number of capacitors within circuit 600 that are enabled determines the kernel weighting for that pixel at that point in time. Capacitors 600 are therefore sometimes referred to as variable weighting capacitors.

The top plate of variable weighing capacitor may be a shared DCG connection that is shared among pixels from one or more rows for better area efficiency (e.g., each variable capacitor bank may be shared among 2-4 rows of pixels, among 4-8 rows of pixels, or among more than 8 pixel rows). Arranged as such, each group of variable sized capacitors can be time shared between multiple rows of pixels. In other suitable arrangements, the shared DCG connection may be shared among multiple columns of pixels (e.g., among 2-4 columns of pixels, among 4-8 columns of pixels, or among more than 8 pixel columns), a rectangular region of pixels, or other suitable groups of pixels.

The value of shared capacitor array 600-1 may be adjusted using first select bits select_wtA. The value of shared capacitor array 600-2 may be adjusted using second select bits select_wtB. The value of shared capacitor array 600-3 may be adjusted using third select bits select_wtC. Operated in this way, the select bits can be varied to control the amount of weight that is multiplied with each pixel value being read out. In other words, the variable sized capacitor may be adjusted to set the desired amount of voltage gain for the photo-generated charge. This technique fits directly into image sensor pixels with dual conversion gain (DCG) functionality without actually changing the internal structure of a DCG pixel itself. The shared DCG capacitors are also used for normal readout of high dynamic range (HDR) signals but only a single fixed sized is used for HDR readout. Connected in this way, the selected value of the weighting capacitors will directly impact the charge and voltage at the floating-diffusion node of each individual pixel (i.e., the weighting occurs within each pixel during readout).

The pixel output line of each pixel may be selectively coupled to a negative (−) input of an integrator 620 via respective switches and resistors R. In FIG. 6A, the first pixel output line ROI_PIX_OUT(1) is coupled to a first serial output bus Serial_Pix_OutA_ROIx, which is selectively coupled to the integrator input via a first selection switch controlled by signal Select_outA and via a first resistor R. The second pixel output line ROI_PIX_OUT(2) is coupled to a second serial output bus Serial_Pix_OutB_ROIx, which is selectively coupled to the integrator input via a second selection switch controlled by signal Select_outB and via a second resistor R. The third pixel output line ROI_PIX_OUT(3) is coupled to a third serial output bus Serial_Pix_OutC_ROIx, which is selectively coupled to the integrator input via a third selection switch controlled by signal Select_outC and via a third resistor R. The serial output bus is a separate local output bus that is part of the ROI processing, which allows this kernel operation to occur in parallel across the entire pixel array. Thus, by selectively asserting the Select_out switches, current from each selected pixel may be read out via the corresponding serial output bus through respective resistor R, which will change the value of the voltage at the (−) input terminal of amplifier 622. This separate local bus also allows normal imaging mode readout to happen in parallel. The resistors R of each column may all have the same value or may optionally have different values. The resistors R may also be implemented as variable resistive circuits for additional gain control. Providing gain in the summing readout path can provide additional flexibility.

Positive power supply voltage Vaa may be selectively applied to the (−) integrator input via an adjustable resistor Rweight_ref by optionally asserting select_ref. Asserting the select_ref switch serves to apply a reference or reset level to the value read out at integrator 620 so that a delta can be established from the actual signal level. If desired, the select_ref switch may also be selectively asserted to apply a predetermined offset voltage to the integrating amplifier 622. The circuits within box 650 and/or the integrator 620 may be formed as part of the intermediate analog feature extraction die 204 (see FIG. 2). Summing the differently weight pixel values can be done using a switched capacitor integrator block 620. Integrator 620 may include an amplifier 622 having a first (+) input configured to receive common mode input voltage Vcm and a second (−) terminal coupled to the different current mode paths. A shared integrating capacitor Cint may be selectively cross-coupled across the input/output of amplifier 822 using switches p1 or p2. A final Vneuron value may be generated at the output of amplifier 622. If desired, other summing mechanisms such as configurations that use a charge domain dynamic capacitor may also be used.

FIG. 6C is a flow chart of illustrative steps for operating the circuitry shown in FIG. 6A. At step 680, auto-zeroing operations may be performed on the integrating amplifier 622 (e.g., by turning on the autozero switch), the p1 switches may be turned on, and the charge on all of the weighting capacitors may be reset (see, e.g., FIG. 6B by asserting control signal Clr_DCG). At step 682, a given row of image pixels may be selected.

At step 684, the value of all weighting capacitors may be set (e.g., by selectively asserting the select_wtX bits controlling each variable capacitor bank 600), and the DCG switches may be turned on to couple the weighting capacitors to the corresponding floating-diffusion nodes.

At step 686, the Select_out switches associated with the positive weighted pixel values (i.e., the positive weighted pixel columns) may be activated, and integrator 620 may be allowed to integrate for a fixed period to time to allow charge at its input and output to settle. At step 688, the p1 switches may be turned off, whereas the p2 switches may be turned on to effectively flip the polarity of integrator 620.

At step 690, the Select_out switches associated with the negative weighted pixel values (i.e., the negative weighted pixel columns) may be activated, and integrator 620 may be allowed to integrate for a fixed period to time to allow charge at its input and output to settle. During this time, the charge from the negative weighted columns will subtract out from the positive weighted column values (i.e., to compute a difference between the positively weighted and negatively weighted pixel values). At step 692, a final Vneuron value may be output by amplifier 622 and subsequently captured.

Although the methods of operations are described in a specific order, it should be understood that other operations may be performed in between described operations, described operations may be adjusted so that they occur at slightly different times or described operations may be distributed in a system which allows occurrence of the processing operations at various intervals associated with the processing, as long as the processing of the overlay operations are performed in a desired way.

These steps and the voltage level of the various relevant signals associated with operating the circuitry of FIG. 6A are illustrated in the timing diagram of FIG. 6D. The timing diagrams assume that photo-generated electrons have been transferred to the pixel floating diffusion node FD1, FD2, FD3 (see FIG. 6A), and these electrons may be from a single pinned photodiode or from multiple pinned photodiodes sharing the FD node or indirectly from photo-generated electrons diffusing to the FD node. In other words, charge accumulation and charge transfer to the FD nodes would have already taken place prior to time t1.

At time t1, the autozero switch, the p1 switches, and the row select switches may all be turned on. At time t1 or shortly after time t1, the charge on all of the in-pixel weighting capacitors may be reset by asserting clr_DCG.

At time t2, the size of all weighting capacitors may be set (e.g., by selectively asserting the sel_wtX bits) while all of the DCG switches in the selected row may be turned on to couple the weighting capacitor banks to the associated floating diffusion nodes. In the example of FIG. 6C, columns A, B, and C may correspond to the positive weighted pixel columns, whereas columns D and E may correspond to the negative weighted pixel columns.

At time t3, the Select_out switches of the positive weighted columns may be activated for a fixed period of time to allow the positive weighted charge to fully settle at the integrator. After the fixed time interval, the row select switches may be turned off.

At time t5, the p1 switches may be turned off, and the p2 switches may be turned on. At this time, the row select transistors may be reactivated. At time t6, the Select_out switches of the negative weighted columns may be activated for a fixed period of time (from time t6 to t7) to allow the negative weighted charge to fully settle at the integrator. At time t8, the kernel operation for that row is complete and all switches may be turned off.

Performing input current mode MAC operations using variable capacitors in this way in the analog domain for each layer of results in the neural network saves power and area by avoiding the need to move data around to the conventional digital memories. The weighting and summing operation utilize only “passive” circuit components such as capacitors and resistors that move charge around. External memory for intermediate results is not needed because the signal processing uses the pixel FD node for storage of the neuron result and the same circuit may be used for processing the next layer in the neural network.

New kernel operations cannot necessarily use previous pixel FD node values because they might be modified or attenuated by the previous DCG weighted capacitor value. Additional gain in the readout path can also help compensate for any changes at the FD node signal value from previous operations. New kernel operations can also operate on pixels signals within a local region that are transferred to an FD node and assumed to be approximately the same value. Alternatively, new kernel operations may need to wait for photo-generate charge to be developed again within the pixel or to transfer only a portion of the pixel photodiode signal to the FD for use in this operation by modifying the high voltage value that controls the transfer gate during charge transfer.

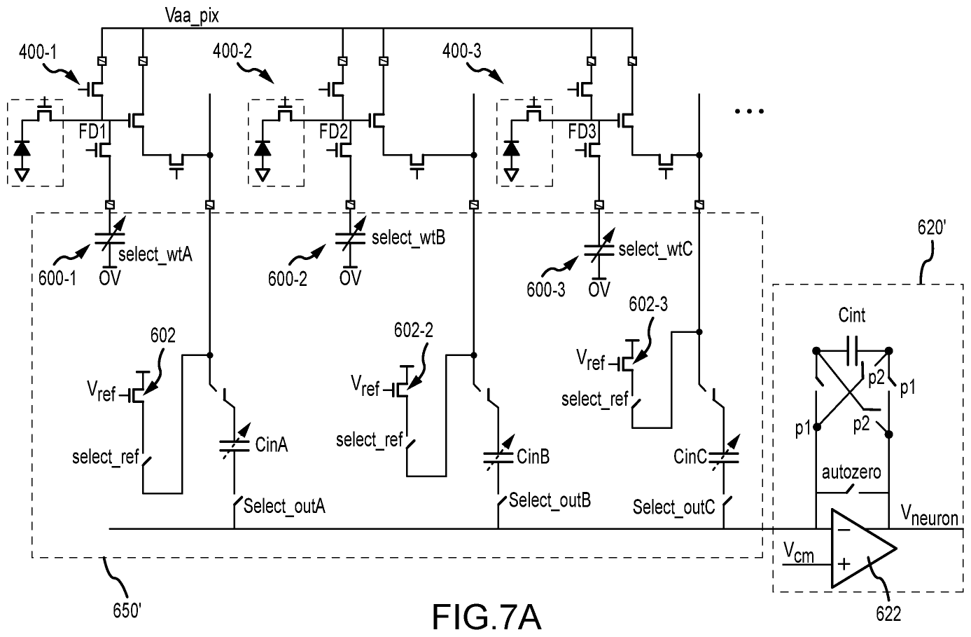

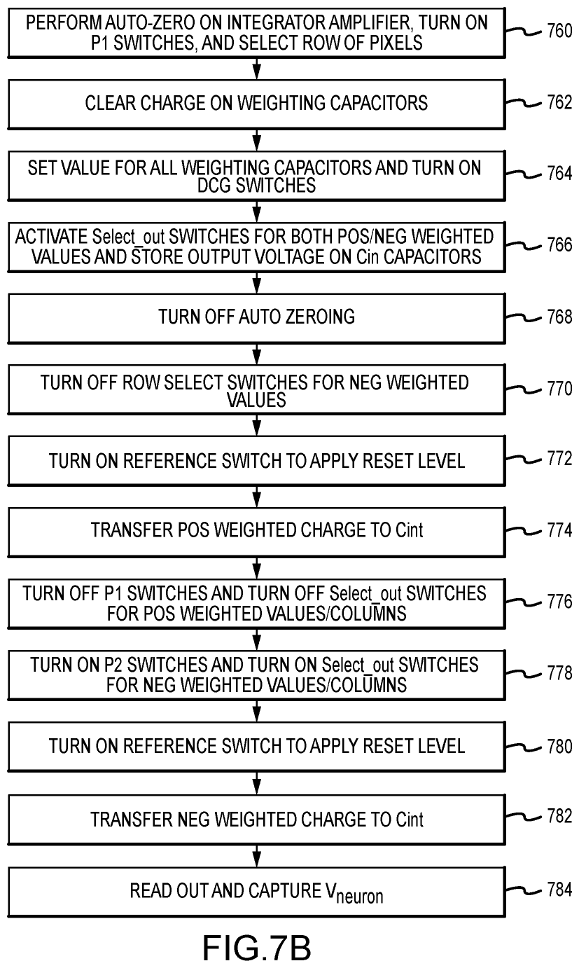

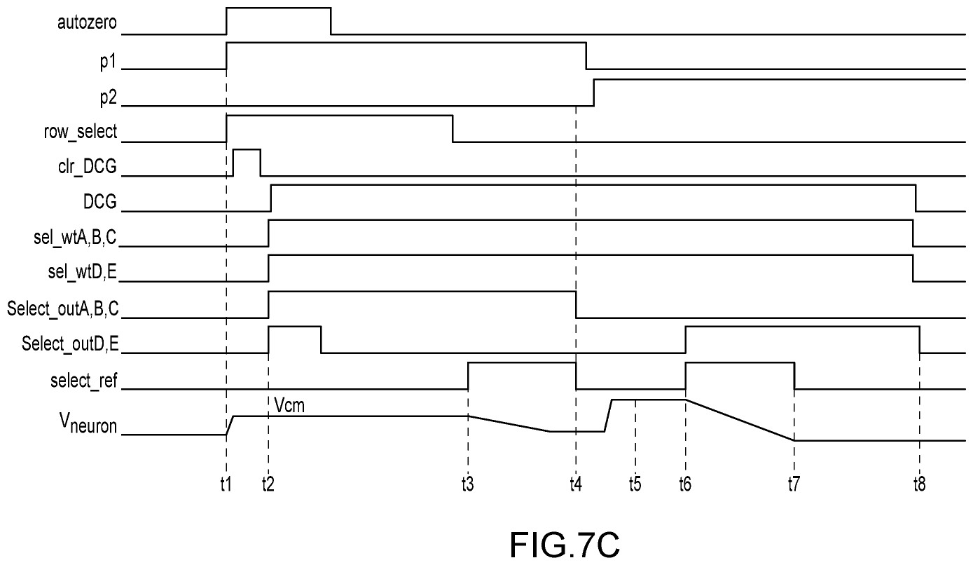

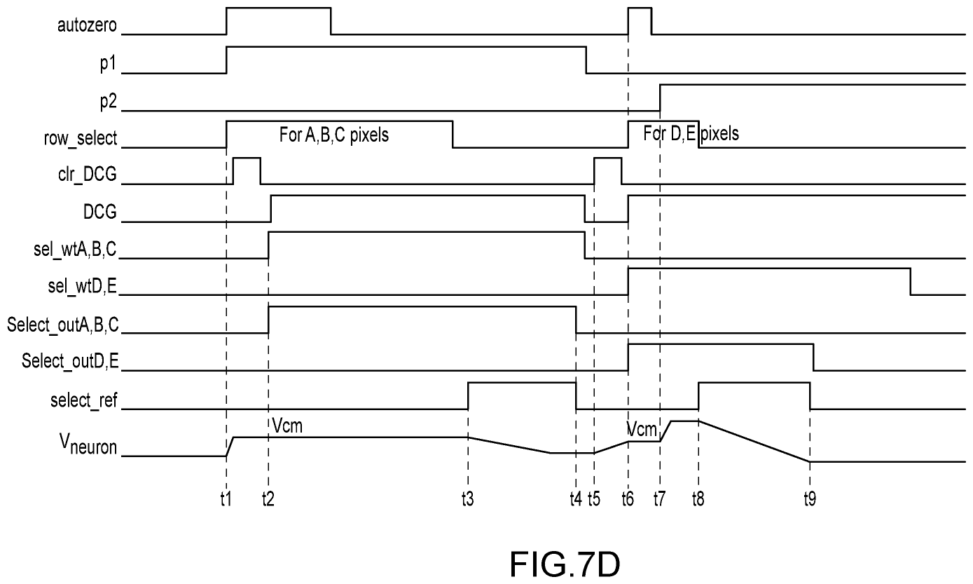

FIG. 7A is a diagram showing how variable weights can be implemented using switched capacitor voltage mode analog multiplier accumulator circuitry in accordance with another suitable arrangement. The pixel output line of each pixel may be selectively coupled to a negative (−) input of integrator 620 via respective switches and capacitors Cin. As shown in FIG. 7A, the first pixel output line ROI_PIX_OUT(1) is coupled to a first serial output bus Serial_Pix_OutA_ROIx, which is selectively coupled to the integrator input via a first selection switch controlled by signal Select_outA and via a first adjustable summing capacitor CinA. The second pixel output line ROI_PIX_OUT(2) is coupled to a second serial output bus Serial_Pix_OutB_ROIx, which is selectively coupled to the integrator input via a second selection switch controlled by signal Select_outB and via a second adjustable summing capacitor CinB. The third pixel output line ROI_PIX_OUT(3) is coupled to a third serial output bus Serial_Pix_OutC_ROIx, which is selectively coupled to the integrator input via a third selection switch controlled by signal Select_outC and via a third adjustable summing capacitor CinC. Thus, by selectively asserting the Select_out switches, an output voltage from each selected pixel may be read out via the corresponding serial output bus through a respective summing capacitor CinX, which will change the value of the voltage at the (−) input terminal of amplifier 622.

A reset voltage may be selectively applied to each pixel output line by optionally asserting the select_ref switch (e.g., by using transistor 602 to apply a reference, reset, or offset voltage to the corresponding summing capacitor). The adjustability of summing capacitors Cin in the summing readout path may optionally provide additional gain control for improved flexibility. In other words, the kernel weights may be controlled by the in-pixel variable weighting capacitors coupled to the floating diffusion nodes via the DCG switches and/or may be controlled by the ROI-level variable summing capacitors CinX interposed in the serial output paths.

The circuits within box 650′ and/or the integrator 620′ may be formed as part of the intermediate analog feature extraction die 204 (see FIG. 2). Summing the differently weighted pixel values can be done using a switched capacitor integrator block 620′. Integrator 620′ may include an amplifier 622 having a first (+) input configured to receive common mode input voltage Vcm and a second (−) terminal coupled to the different current mode paths. A shared integrating capacitor Cint may be selectively cross-coupled across the input/output of amplifier 822 using switches p1 or p2. A final Vneuron value may be generated at the output of comparator 622. If desired, other summing mechanisms may also be used.

FIG. 7B is a flow chart of illustrative steps for operating the voltage mode accumulator circuitry shown in FIG. 7A. At step 760, auto-zeroing operations may be performed at the integrating amplifier 622 (e.g., by turning on the autozero switch), the p1 switches may be turned on, and a given row of image pixels may be selected. At step 762, the charge on all of the weighting capacitors may be cleared.

At step 764, the value of all weighting capacitors may be set (e.g., by selectively asserting the select_wtX bits controlling each variable capacitor bank 600), and the DCG switches may be turned on to couple the weighting capacitors to the corresponding floating-diffusion nodes.

At step 766, the Select_out switches for both the positive and negative weighted columns may be enabled, and the output voltage read out from the pixel output lines may be routed for storage at the Cin capacitors using the respective serial/local output buses.

At step 768, the autozero switch may be turned off. At step 770, the row select switches for the negatively weighted pixel values may be turned off. At step 772, the select_ref switch may be turned on to apply a reset/reference level to the value read out at integrator 620′ so that a delta can be established from the actual signal level. At step 774, the positively weighted charge may be transferred to capacitor Cint at integrator 620′.

At step 776, the p1 switches may be turned off while the Select_out switches associated with the positively weighted pixel values (i.e., the POS weighted pixel columns) are deactivated. At step 778, the p2 switches are turned on to flip the polarity of integrator 620′, and the Select_out switches associated with the negatively weighted pixel values (i.e., the NEG weighted pixel columns) are activated.

At step 780, the select_ref switch may be turned on to apply a reset/reference level to the value read out at integrator 620′ so that a delta can be established from the actual negative weighted signal level. At step 782, the negatively weighted charge may be transferred to capacitor Cint at integrator 620′. At step 784, a final Vneuron value may be output by amplifier 622 and subsequently captured.

These steps are merely illustrative and are not intended to limit the present embodiments. At least some of the existing steps may be modified or omitted; some of the steps may be performed in parallel; additional steps may be added or inserted; and the order of certain steps may be reversed or altered.

The voltage level of the various relevant signals associated with operating the circuitry of FIG. 7A are illustrated in the timing diagram of FIG. 7C. Prior to time t1, charge accumulation and charge transfer to the FD nodes would have already taken place.

At time t1, the autozero switch, the p1 switches, and the row select switches may all be turned on. At time t1 or shortly after time t1, the charge on all of the in-pixel weighting capacitors may be reset by asserting clr_DCG.

At time t2, the size of all weighting capacitors may be set (e.g., by selectively asserting the sel_wtX bits) while all of the DCG switches in the selected row may be turned on to couple the weighting capacitor banks to the associated floating diffusion nodes. In the example of FIG. 7B, columns A, B, and C may correspond to the positive weighted pixel columns, whereas columns D and E may correspond to the negative weighted pixel columns.

At time t2, the Select_out switches for both the positive and negative weighted columns may be activated to allow the positive and negative weighted charge to accumulate at the Cin capacitors. After some time, the Select_out switches for the negative pixel values may be turned off. The row select switches may subsequently be turned off.

At time t3, the select_ref switch may be enabled to apply a reset voltage, and the resulting charge may be transferred to integrating capacitor Cint.

At time t4, the p1 switches may be turned off, and the p2 switches may be turned on. At this time, the Select_out switches for the positive weighted pixel values may be deasserted. During this time, polarity of the switched capacitor integrator 620′ is flipped and charge may be allowed to settle (see time t5).

At time t6, the Select_out switches for the negative weighted pixel values may be asserted while the select_ref switch is enabled to apply a reset voltage. During this time (from t6 to t7), the resulting charge associated with the negatively weighted pixel values may be transferred to integrating capacitor Cint. At time t8, the kernel operation for that row is complete and all switches may be turned off.

FIG. 7D is a timing diagram showing relevant signals for operating the circuitry shown in FIG. 7A when the variable weighting capacitors are shared among multiple rows. In particular, FIG. 7D illustrates the positively weighted charge transfer for pixels A, B, and C from the DCG capacitors. The negatively weighted charge transfer from pixels D and E may occur after clearing out the charge from the earlier A and B transfers.

At time t1, the autozero switch, the p1 switches, and the row select switches for pixels A, B, and C may be turned on. At time t1 or shortly after time t1, the charge on all of the in-pixel weighting capacitors may be reset by asserting clr_DCG.

At time t2, the size of the positive weighting capacitors may be set (e.g., by selectively asserting the sel_wtA/B/C bits) while all the DCG switches may be turned on to couple the weighting capacitor banks to the associated floating diffusion nodes. At time t2, the Select_out switches for the positive weighted columns may also be activated to allow the positive weighted charge to accumulate at the corresponding Cin capacitors. The row select switches may subsequently be turned off.

At time t3, the select_ref switch may be enabled to apply a reset voltage, and the resulting accumulated positively weighted charge may be transferred to integrating capacitor Cint.

At time t4, the select_ref switch is disabled, and the all switches associated with the positive weighted pixels may be turned off (e.g., the p1 switches may be turned off, the Select_out switches for the positive weighted columns may be deactivated), and the DCG switches may be turned off to decouple the weighting capacitors from the floating diffusion nodes.

At time t5, the clr_DCG signal may again be pulsed high to clear the charge from the positively weighted A, B, and C pixels.

At time t6, the autozero switch may again be turned on so that the negatively weighted D and E pixel values may be stored on the Cin capacitors. At this time, the row select switches for pixels D and E may be turned on, all DCG switches may be turned on to couple the weighting capacitor banks to the associated floating diffusion nodes, the size of the negative weighting capacitors may be set (e.g., by selectively asserting the sel_wtD/E bits), and the Select_out switches for the negative weighted columns may be activated to allow the negative weighted charge to accumulate at the corresponding Cin capacitors.

At time t7, the p2 switches may be turned on. During this time, polarity of the switched capacitor integrator 620′ is flipped and charge may be allowed to settle. At time t8, the select_ref switch is enabled to apply a reset voltage. During this time (from time t8 to t9), the resulting charge associated with the negatively weighted pixel values may be transferred to integrating capacitor Cint. At time t9, the kernel operation for that row is complete and all switches may be turned off.

Performing input current mode MAC operations using only variable capacitors in these ways in the analog domain for each layer of results in the neural network saves power and area by avoiding the need to move data around to the conventional digital memories. The weighting and summing operation utilize only “passive” capacitor circuit components for moving charge around. External memory for intermediate results is not needed because the signal processing uses the pixel FD node for storage of the neuron result and the same circuit may be used for processing the next layer in the neural network.

The foregoing is merely illustrative of the principles of this invention and various modifications can be made by those skilled in the art without departing from the scope and spirit of the invention. The foregoing embodiments may be implemented individually or in any combination.

What is claimed is:

1. Imaging circuitry, comprising:
a first pixel having a first floating diffusion node;
a first adjustable circuit configured to apply a first weight to the first floating diffusion node so that the first pixel outputs a first weighted pixel value;
a second pixel having a second floating diffusion node;
a second adjustable circuit configured to apply a second weight to the second floating diffusion node so that the second pixel outputs a second weighted pixel value; and
an output circuit configured combine the first and second weighted pixel values to generate a corresponding analog output voltage.

2. The imaging circuitry of claim 1, wherein the first and second pixels are formed on a first die, and wherein the first and second adjustable circuits and the output circuit are formed on a second die.

3. The imaging circuitry of claim 2, wherein the first die is stacked on top of the second die.

4. The imaging circuitry of claim 1, wherein the first adjustable circuit comprises a variable capacitor.

5. The imaging circuitry of claim 1, further comprising:
a dual conversion gain switch interposed between the first floating-diffusion node and the first adjustable circuit.

6. The imaging circuitry of claim 1, wherein the output circuit comprises:
an amplifier having a negative input and a positive input;
a first resistor coupled between the negative input of the amplifier and a first pixel output line of the first pixel; and
a second resistor coupled between the negative input of the amplifier and a second pixel output line of the second pixel.

7. The imaging circuitry of claim 6, wherein the output circuit further comprises:
a first switch coupled in series with the first resistor; and
a second switch coupled in series with the second resistor.

8. The imaging circuitry of claim 6, wherein the output circuit further comprises:
a reference switch configured to apply a reset voltage to the negative input of the amplifier.

9. The imaging circuitry of claim 8, wherein the output circuit further comprises:
a variable weighting resistor coupled in series with the reference switch.

10. The imaging circuitry of claim 6, wherein the amplifier is configured to receive a common mode voltage at its positive input, and wherein the output circuit further comprises:
a integrating capacitor coupled to at least one of the positive and negative inputs;
a first group of switches operable to couple the integrating capacitor to the amplifier in a first configuration; and
a second group of switches operable to couple the integrating capacitor to the amplifier in a second configuration different than the first configuration.

11. The imaging circuitry of claim 1, wherein the output circuit comprises:
an amplifier having a negative input and a positive input;
a first summing capacitor coupled between the negative input of the amplifier and a first pixel output line of the first pixel; and
a second summing capacitor coupled between the negative input of the amplifier and a second pixel output line of the second pixel.

12. The imaging circuitry of claim 11, wherein the output circuit further comprises:
a first switch coupled in series with the first summing capacitor; and
a second switch coupled in series with the second summing capacitor.

13. The imaging circuitry of claim 11, wherein the output circuit further comprises:
a first reference switch configured to apply a reset voltage to the first summing capacitor; and
a second reference switch configured to apply the reset voltage to the second summing capacitor.

14. The imaging circuitry of claim 11, wherein the first and second summing capacitors comprise adjustable capacitors.

15. The imaging circuitry of claim 1, wherein the first adjustable circuit is shared among multiple pixel rows.

16. A method of operating imaging circuitry, comprising:
using a first kernel weighting circuit to apply a first weight to a first pixel, wherein the first kernel weighting circuit is configured to alter the voltage at a floating diffusion node of the first pixel; and
using a second kernel weighting circuit to apply a second weight to a second pixel, wherein the second kernel weighting circuit is configured to alter the voltage at a floating diffusion node of the second pixel.

17. The method of claim 16, further comprising:
adjusting the first kernel weighting circuit to change the first weight.

18. The method of claim 16, further comprising:
activating a first dual conversion gate switch to couple the first kernel weighting circuit to the floating diffusion node of the first pixel; and
activating a second dual conversion gate switch to couple the second kernel weighting circuit to the floating diffusion node of the second pixel.

19. The method of claim 16, wherein the first and second kernel weighting circuits comprise variable capacitor circuits, the method further comprising:
clearing the variable capacitor circuits;
activating a first output switch to read out a positively weighted pixel value from the first pixel;
activating a second output switch to read out a negatively weighted pixel value from the second pixel; and
computing a difference between the positively weighted pixel value and the negatively weighted pixel value.

20. An image sensor pixel, comprising:
a floating diffusion node;
an adjustable kernel weighting circuit configured to apply an adjustable kernel weight to the floating diffusion node; and
a dual conversion gain switch coupled between the floating diffusion node and the adjustable kernel weighting circuit.
